(19) United States
(12) Patent Application Publication
(10) Pub. No.: US 2012/0124526 A1
(43) Pub. Date: May 17, 2012

(54) METHOD FOR CONTINUING A FUNCTION INDUCED BY A MULTI-TOUCH GESTURE ON A TOUCHPAD

(76) Inventors: Yen-Yu LIN, New Taipei City (TW); Wen-Shu Chen, Taoyuan County (TW)

(21) Appl. No.: 13/295,730

(22) Filed: Nov. 14, 2011

(30) Foreign Application Priority Data
Nov. 16, 2010 (TW) 099139333

(51) Int. Cl. G06F 3/033

(52) U.S. Cl. 715/863

(57) ABSTRACT

In a method for continuing a function induced by a multi-touch gesture on a touchpad, the object number of the multi-touch gesture is monitored during the function is performed, if the object number is detected changed so that one or more objects are still on the touchpad, the objects left on the touchpad will be detected to identify whether one or more of them move clockwise or anticlockwise, and if a clockwise or anticlockwise movement is detected, the function will be continued.

### FIELD OF THE INVENTION

The present invention is related generally to touch control and, more particularly to a method for continuing a function induced by a multi-touch gesture on a touchpad.

### BACKGROUND OF THE INVENTION

While touch control allows intuitive operation, such operation is limited by the size of the operational interface such as touchpads, and thus usually requires repeating several times of a same gesture operation to complete a desired result. For example, in the case of using a graphical user interface (GUI), it is usually to drag a scrollbar for browsing an entire image; however, due to the limitation of a small touchpad, the drag gesture has to be repeated for many times before the desired scrolling distance is achieved. U.S. Pat. No. 7,446,754 discloses a method of generating a one-dimensional scrolling signal responsive to a clockwise or anticlockwise movement on a touchpad and determining the scrolling amount according to the distance of the movement, which may eliminate the limitation caused by the size of the touchpad.

Nowadays, touch control technology has been developed from single-touch operation to multi-touch operation. The multi-touch operation further diversifies touch control instructions, for example, different multi-touch gestures can induce different functions, such as zoom-in, zoom-out, rotation and scrolling, which allows more intuitive operations by using a touchpad. However, a multi-touch operation is also limited by the size of touchpads, and is further subject to users' gesture which may cause the effect to be presented incompletely, and need to be repeated for many times. For instance, when a user moves his two fingers on a touchpad close to each other to zoom out an image, if his two fingers have contacted mutually but the image has not been scaled down to the desired size, the user must lift his fingers from the touchpad and then repeat the same multi-touch gesture, i.e., moving his two fingers on the touchpad close to each other again, to continue the zoom-out function until the image is scaled down to his target size. This is convenient for operating with a touchpad.

Therefore, it is desired a method for continuing a function induced by a multi-touch gesture on a touchpad.

### SUMMARY OF THE INVENTION

An objective of the present invention is to provide a method for continuing a function induced by a multi-touch gesture on a touchpad.

Another objective of the present invention is to provide a method for more convenient operation with a touchpad to complete a function induced by a multi-touch gesture on the touchpad.

According to the present invention, a method for continuing a function induced by a multi-touch gesture on a touchpad includes monitoring the object number of the multi-touch gesture during the function is performed and then, if the object number of the multi-touch gesture is detected changed, detecting whether any object left on the touchpad moves clockwise or anticlockwise on the touchpad. If a clockwise or anticlockwise movement on the touchpad is detected, the function will be continued.

### BRIEF DESCRIPTION OF THE DRAWINGS

These and other objectives, features and advantages of the present invention will become apparent to those skilled in the art upon consideration of the following description of the preferred embodiments of the present invention taken in conjunction with the accompanying drawings, in which:

FIG. 1 is a flowchart of a method in an embodiment according to the present invention;

FIG. 2 is a flowchart of an embodiment for step S14 of the method shown in FIG. 1;

FIG. 3 is a flowchart of an embodiment for step S18 of the process shown in FIG. 2;

FIG. 4 is a flowchart of an embodiment for step S20 of the process shown in FIG. 2;

FIG. 5 is a flowchart of an embodiment for step S22 of the process shown in FIG. 2;

FIG. 6 is a flowchart of an embodiment for step S24 of the process shown in FIG. 2; and

FIG. 7 schematically illustrates a clockwise movement and an anticlockwise movement of an object on a touchpad.

### DETAILED DESCRIPTION OF THE INVENTION

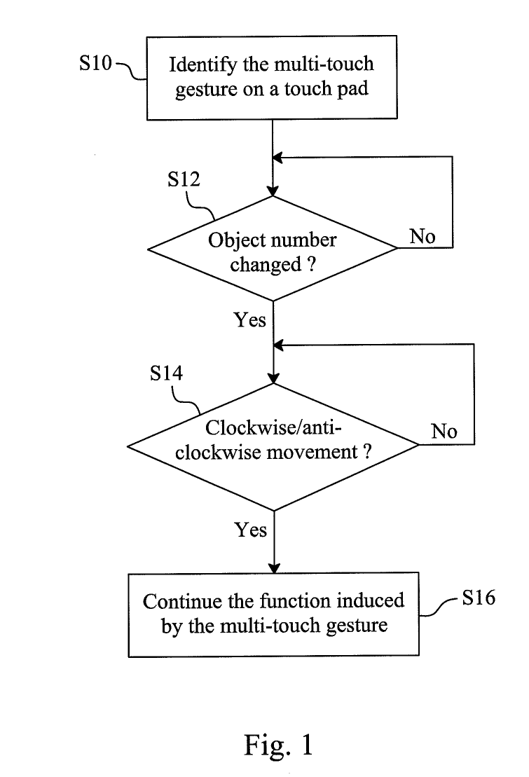

FIG. 1 is a flowchart of a method in an embodiment according to the present invention. Step S10 identifies the multi-touch gesture on a touchpad as conventionally does and it is well known that, after the multi-touch gesture is identified, a corresponding function will be performed. For example, a zoom-in or zoom-out function for displaying an image will be performed responsive to an approaching or departing movement of two fingers on the touchpad. During the function is performed, step S12 monitors the number of the objects on the touchpad, and once the object number on the touchpad is detected changed, increased or decreased, step S14 will be performed. Step S12 is to use the change of the object number on the touchpad as an assistant to determine whether to continue the function induced by the multi-touch gesture that is identified in step S10. The change of the object number may be the case of from multiple fingers to single finger, e.g. from two fingers to one finger, from multiple fingers to more multiple fingers, e.g. from two fingers to three fingers, or from multiple fingers to less multiple fingers, e.g. from three fingers to two fingers, etc. Further details for a touchpad to detect the number of objects on the touchpad and to identify a multi-touch gesture on the touchpad may refer to related arts, e.g. U.S. Pat. Nos. 5,825,352 and 6,323,846.

Step S14 is to use the movement of the object(s) left on the touchpad as an assistant to determine whether to continue the function induced by the multi-touch gesture that is identified in step S10. Particularly, it is to detect if any or all objects left on the touchpad move clockwise or anticlockwise. In an embodiment, only an object is detected left on the touchpad, and the moving track of the single object on the touchpad is used to identify whether a clockwise movement or an anticlockwise movement on the touchpad is made by the single object. In another embodiment, there are multiple objects detected left on the touchpad, it may use the moving tracks of all the multiple objects, the moving track of the gravity center of the multiple objects, or the moving track of one of the multiple objects to identify whether a clockwise movement or an anticlockwise movement is made on the touchpad. If a clockwise movement or an anticlockwise movement is detected in step S14, then step S16 is performed to continue the function induced by the multi-touch gesture that is identified in step S10. At last, when the number of the object(s) on the touchpad is detected changed again, e.g. no finger left on the touchpad, the process of continuing the function ends. In an embodiment, step S16 further determines the effect of the continued function depending on the time period where the clockwise movement or the anticlockwise movement lasts. In an embodiment, the longer the time period is, the stronger the effect is. For example, the scrolling speed increases with the lapse of the moving time. In another embodiment, step S16 further determines the effect of the continued function depending on the moving distance of the clockwise movement or the anticlockwise movement. In an embodiment, the greater the moving distance is, the stronger the effect is. For example, the scrolling speed increases with the accumulative moving distance.

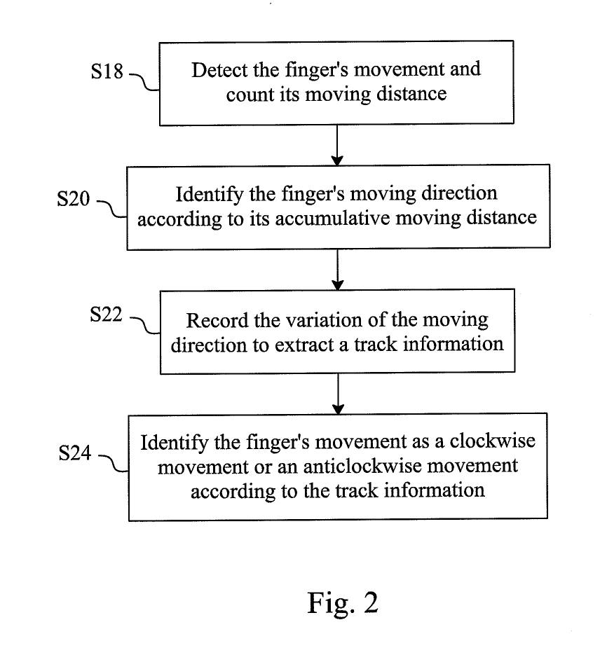

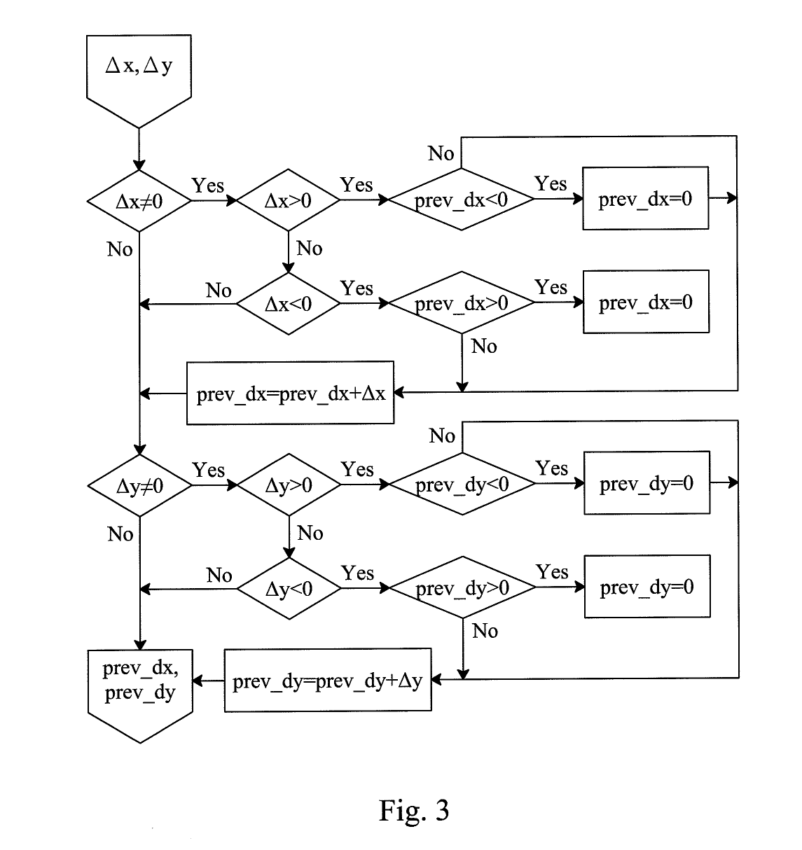

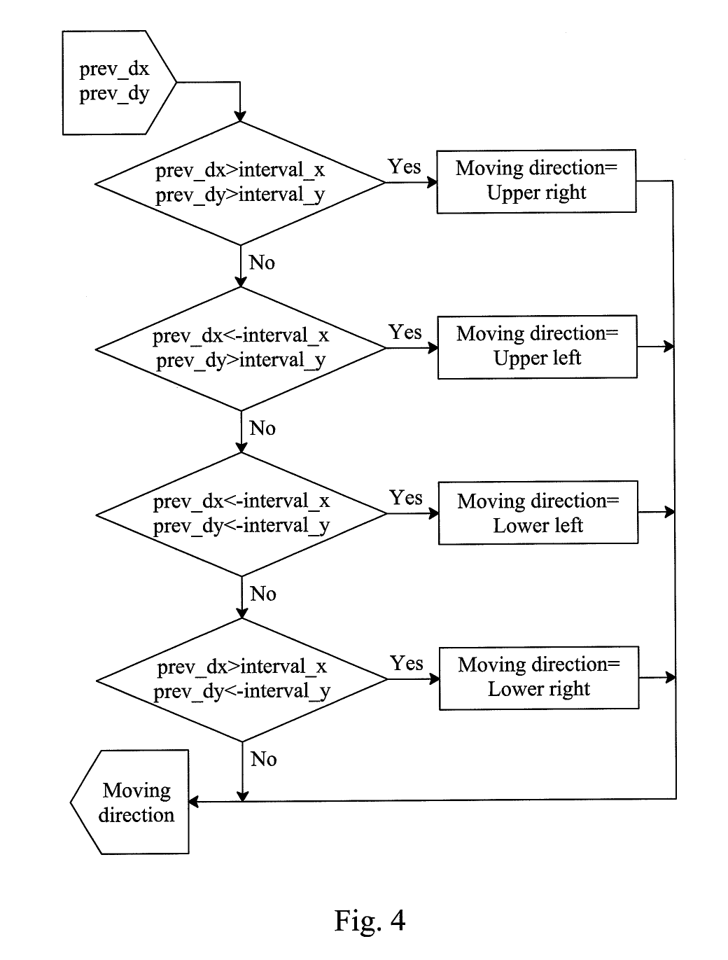

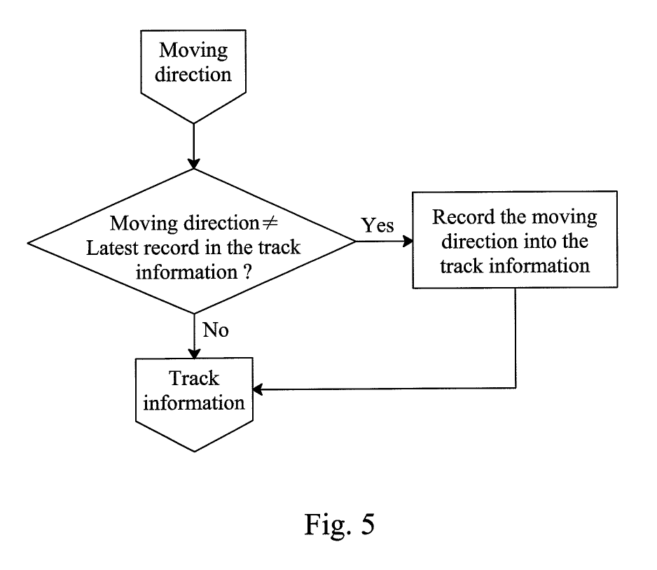

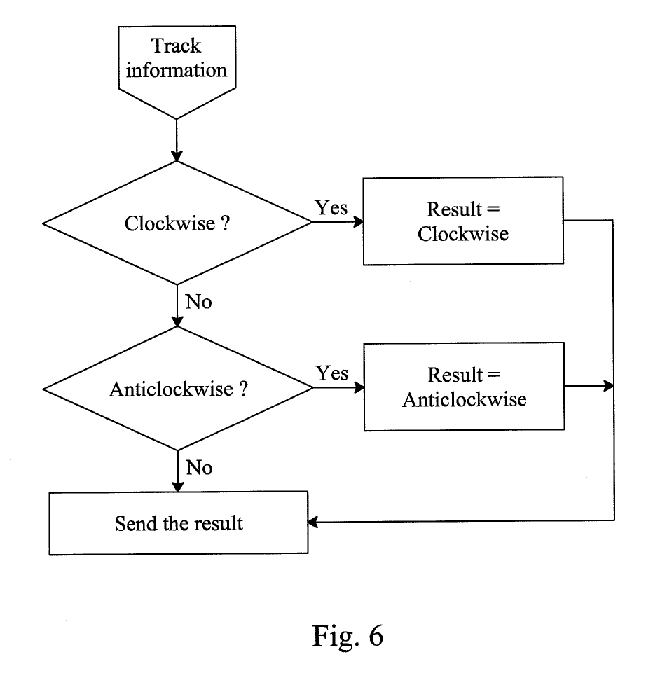

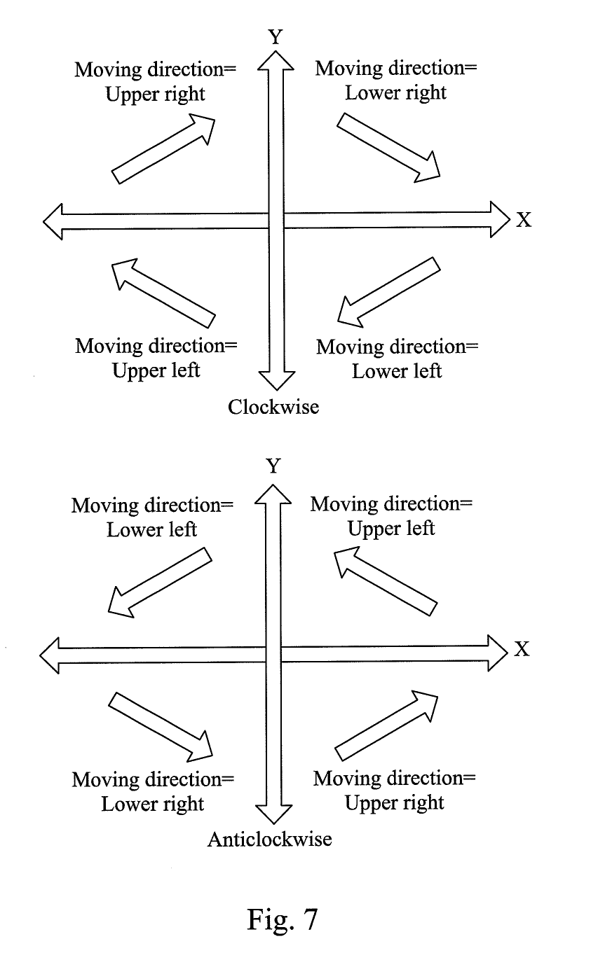

FIG. 2 is a flowchart of an embodiment for step S14 of the method shown in FIG. 1, and each of steps S18-S24 shown in FIG. 2 is provided with an embodiment as shown in FIGS. 3-6, respectively. These embodiments are exemplarily described in the case that step S12 has detected a change of from multiple fingers to a single finger, to further illustrate how to identify a finger movement on the touchpad is clockwise or anticlockwise. When step S12 shown in FIG. 1 identifies that the number of the fingers on a touchpad has become one from plural, referring to FIG. 2, step S18 is performed to detect the finger's movement and count its moving distance, and then step S20 identifies the finger's moving direction according to its accumulative moving distance. Step S22 records the variation of the moving direction to extract a track information. At last, step S24 identifies the finger's movement as a clockwise movement or an anticlockwise movement according to the track information. In an embodiment, the coordinates of the finger's position on the touchpad are defined with respect to a two-dimensional plane extending in X-direction and Y-direction, and thus the finger's movement will cause a variation of the XY coordinates, resulting in differences Δx and Δy of the coordinates in the X-direction and the Y-direction, respectively. The detailed process of step S18 is shown in FIG. 3, which includes identifying the number signs, i.e. positive or negative, of the differences Δx and Δy of the XY coordinates, and accumulating the differences Δx and Δy of the XY coordinates, to obtain the X- and Y-directions' accumulative moving distances prev_dx and prev_dy. When Δx (or Δy) has its number sign changed, the accumulative moving distance prev_dx (or prev_dy) is recounted. The following step S20, as shown in FIG. 4, includes comparing the X- and Y-directions' moving distances prev_dx and prev_dy with thresholds internal_x and internal_y, respectively, and according to the comparison result, determining the finger's moving direction as toward lower right, lower left, upper left or upper right. The thresholds internal_x and internal_y are used to prevent erroneous determination, and may be changed according to users' setting. The detailed process of step S22 is shown in FIG. 5, which includes comparing the moving direction obtained from step S20 as shown in FIG. 4 with the latest record of the track information. In the event that the moving direction is different from the latest record of the track information, the moving direction will be recorded into the track information. The detailed process of step S24 is shown in FIG. 6, which includes comparing the track information with the clockwise movement and anticlockwise movement as shown in FIG. 7, to thereby determine whether the variation of the moving direction of the track information matches the clockwise movement or the anticlockwise movement, and sending back the result for step S16 to continue the function induced by the multi-touch gesture that is identified in step S10. In an embodiment, comparison is conducted among the latest plural records about the moving direction contained in the track information, so as to determine whether the finger's moving track indicates a clockwise movement or an anticlockwise movement. For example, in the event that the latest three records of the track information are upper right (latest), upper left (second latest) and lower left, as shown in the upper part of FIG. 7, the finger's moving track will be identified as a clockwise movement.

In applications of the present invention, if a multi-touch gesture has an opposite multi-touch gesture to induce a function opposite to the function induced by the former, then the two opposite functions, for example, zoom-in and zoom-out, or right rotation and left rotation, can be integrated in a step for control, to be continued by clockwise movement and anticlockwise movement, respectively. For example, the default of a touchpad is that a clockwise movement will continue the function, e.g. scaling up an image, induced by the originally identified multi-touch gesture, and an anticlockwise movement will induce an opposite function, i.e. scaling down an image, to the function induced by the originally identified multi-touch gesture, so that a user who continues the function induced by a multi-touch gesture excessively can conveniently perform reverse adjustment to the desired result.

In another embodiment, when step S14 identifies the finger's movement as a clockwise movement (or an anticlockwise movement), step S16 will continue the effect of the multi-touch gesture. If the finger turns to an anticlockwise movement (or a clockwise movement) before the condition of ending the continuation of the multi-touch gesture, the function opposite to the function induced by the original multi-touch gesture will be performed. For example, scaling up will turn to scaling down, or right rotation will turn left rotation.

In different embodiments, different technical means may be employed to identify whether the finger(s) is (are) moving clockwise or anticlockwise, for example, by using a special layout of sensing electrodes in a touchpad, or an algorithm, such as disclosed by U.S. Pat. No. 7,446,754.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A method for continuing a function induced by a multi-touch gesture on a touchpad, comprising the steps of:
a.) monitoring a number of the objects on the touchpad during the function is performed;
b.) if the number of the objects is detected changed to leave only a single object on the touchpad, identifying whether the single object moves clockwise or anticlockwise on the touchpad; and
c.) if a clockwise or anticlockwise movement is detected, continuing the function responsive to the detected clockwise or anticlockwise movement.

2. The method of claim 1, wherein the step b comprises the steps of:
monitoring the single object's movement on the touchpad and counting its moving distance to obtain an accumulative moving distance;
identifying a moving direction of the single object according to the accumulative moving distance;
recording a variation of the moving direction to extract a track information; and
determining whether the single object has a clockwise or anticlockwise movement according to the track information.

3. The method of claim 2, wherein the step of monitoring the single object's movement on the touchpad and counting its moving distance to obtain an accumulative moving distance comprises the steps of:
using coordinates of the single object on the touchpad to identify whether the single object has a movement; and
calculating differences of the coordinates to obtain the moving distance.

4. The method of claim 2, wherein the step of identifying a moving direction of the single object according to the accumulative moving distance comprises the step of determining the moving direction as one of four directions including lower right, lower left, upper left and upper right.

5. The method of claim 2, wherein the step of recording a variation of the moving direction to extract a track information comprises the step of recording the moving direction into the track information when the moving direction is different from a latest record of the track information.

6. The method of claim 2, wherein the step of determining whether the single object has a clockwise or anticlockwise movement according to the track information comprises the step of using a plurality of latest records of the track information to determine whether the single object has a clockwise or anticlockwise movement.

7. The method of claim 1, further comprising the step of determining an effect of the function according to a time period of the detected clockwise or anticlockwise movement.

8. The method of claim 1, further comprising the step of determining an effect of the function according to a moving distance of the detected clockwise or anticlockwise movement.

9. The method of claim 1, further comprising the steps of:
if a clockwise movement is detected, continuing the function already performed; and
if an anticlockwise movement is detected, continuing a function opposite to the function already performed.

10. The method of claim 1, further comprising the steps of:
if a clockwise or anticlockwise movement is first detected, continuing the function already performed; and
if the moving direction is reversed, continuing a function opposite to the function already performed.

11. A method for continuing a function induced by a multi-touch gesture on a touchpad, comprising the steps of:
a.) monitoring a number of the objects on the touchpad during the function is performed;
b.) if the number of the objects is detected changed so that a plurality of objects are still on the touchpad, identifying whether one or more of the plurality of objects move clockwise or anticlockwise on the touchpad; and
c.) if a clockwise or anticlockwise movement is detected, continuing the function responsive to the detected clockwise or anticlockwise movement.

12. The method of claim 11, wherein the step b comprises the step of selecting one of the plurality of objects on the touchpad to be identified whether it moves clockwise or anticlockwise.

13. The method of claim 12, wherein the step b comprises the steps of:
monitoring the selected object's movement on the touchpad and counting its moving distance to obtain an accumulative moving distance;
identifying a moving direction of the selected object according to the accumulative moving distance;
recording a variation of the moving direction to extract a track information; and
determining whether the selected object has a clockwise or anticlockwise movement according to the track information.

14. The method of claim 13, wherein the step of monitoring the selected object's movement on the touchpad and counting its moving distance to obtain an accumulative moving distance comprises the steps of:
using coordinates of the selected object on the touchpad to identify whether the selected object has a movement; and
calculating differences of the coordinates to obtain the moving distance.

15. The method of claim 13, wherein the step of identifying a moving direction of the selected object according to the accumulative moving distance comprises the step of determining the moving direction as one of four directions including lower right, lower left, upper left and upper right.

16. The method of claim 13, wherein the step of recording a variation of the moving direction to extract a track information comprises the step of recording the moving direction into the track information when the moving direction is different from a latest record of the track information.

17. The method of claim 13, wherein the step of determining whether the selected object has a clockwise or anticlockwise movement according to the track information comprises the step of using a plurality of latest records of the track information to determine whether the selected object has a clockwise or anticlockwise movement.

18. The method of claim 11, wherein step b comprises the step of selecting a gravity center of the plurality of objects on the touchpad to be identified whether it moves clockwise or anticlockwise.

19. The method of claim 18, wherein the step b comprises the steps of:
monitoring the gravity center's movement on the touchpad and counting its moving distance to obtain an accumulative moving distance;
identifying a moving direction of the gravity center according to the accumulative moving distance;
recording a variation of the moving direction to extract a track information; and
determining whether the gravity center has a clockwise or anticlockwise movement according to the track information.

20. The method of claim 19, wherein the step of monitoring the gravity center's movement on the touchpad and counting its moving distance to obtain an accumulative moving distance comprises the steps of:
using coordinates of the gravity center on the touchpad to identify whether the gravity center has a movement; and
calculating differences of the coordinates to obtain the moving distance.

21. The method of claim 19, wherein the step of identifying a moving direction of the gravity center according to the accumulative moving distance comprises the step of determining the moving direction as one of four directions including lower right, lower left, upper left and upper right.

22. The method of claim 19, wherein the step of recording a variation of the moving direction to extract a track information comprises the step of recording the moving direction into the track information when the moving direction is different from a latest record of the track information.

23. The method of claim 19, wherein the step of determining whether the gravity center has a clockwise or anticlockwise movement according to the track information comprises the step of using a plurality of latest records of the track information to determine whether the gravity center has a clockwise or anticlockwise movement.

24. The method of claim 11, further comprising the step of determining an effect of the function according to a time period of the detected clockwise or anticlockwise movement.

25. The method of claim 11, further comprising the step of determining an effect of the function according to a moving distance of the detected clockwise or anticlockwise movement.

26. The method of claim 11, further comprising the steps of:
if a clockwise movement is detected, continuing the function already performed; and
if an anticlockwise movement is detected, continuing a function opposite to the function already performed.

27. The method of claim 11, further comprising the steps of:
if a clockwise or anticlockwise movement is first detected, continuing the function already performed; and
if the moving direction is reversed, continuing a function opposite to the function already performed.
